(19) United States
(12) Patent Application Publication
(10) Pub. No.: US 2025/0021336 A1
(43) Pub. Date: Jan. 16, 2025

(54) POLARITY-BASED DATA PREFETCHER WITH UNDERLYING STRIDE DETECTION

(71) Applicant: Akeana, Inc., San Jose, CA (US)

(72) Inventor: Rabin Sugumar, Sunnyvale, CA (US)

(73) Assignee: Akeana, Inc., San Jose, CA (US)

(21) Appl. No.: 18/768,088

(22) Filed: Jul. 10, 2024

Related U.S. Application Data
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.

(51) Int. Cl. G06F 9/38; G06F 9/32

(52) U.S. Cl. CPC G06F 9/3802; G06F 9/321; G06F 9/3836

(57) ABSTRACT

A processor core includes a local cache hierarchy, prefetch logic, and a prefetch table, where the processor core is coupled to an external memory system. A data stream is detected, where the data stream includes multiple load instructions, including a load instruction that causes a cache miss, resulting in prefetching. A prefetch table is initialized with information pertaining to load instructions, and includes a Positive or Negative value (PON), a stride, and a saturation count. Information in the prefetch table is updated as new load instructions are prefetched. An underlying stride of the data stream is discovered, based on the updating. Data is prefetched using an offset, where a polarity of the offset is based on the PON, enabling effective stride detection with dynamic directionality and out-of-order instructions.

### RELATED APPLICATIONS

This application claims the benefit of U.S. provisional patent applications “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563, 102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, and “Direct Data Transfer With Cache Line Owner Assignment” Ser. No. 63/653,402, filed May 30, 2024.

Each of the foregoing applications is hereby incorporated by reference in its entirety.

### FIELD OF ART

This application relates generally to computer processors and more particularly to a polarity-based data prefetcher with underlying stride detection.

### BACKGROUND

Computer processors play a crucial role in modern society and have transformed various aspects of everyday life. Processors are used in many key areas, including communication and connectivity. Processors enable instant communication and global connectivity through the Internet. They facilitate email, social media, video conferencing, and other digital communication tools that have revolutionized how people interact and collaborate. Many industries rely heavily on computer processors for daily tasks. Thus, processors have become an essential part of modern society, impacting numerous aspects of daily life, from communication and work to education, entertainment, healthcare, and scientific research. Their ever-increasing computational power has transformed industries and enabled new possibilities, contributing to the advancement of society as a whole.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Processors typically include an arithmetic logic unit (ALU). The ALU performs mathematical calculations (addition, subtraction, multiplication, division) and logical operations required for data processing. Processors can include multiple registers. Registers are small, high-speed memory units within the processor used for temporary data storage during processing. They hold data, addresses, and control information needed for instruction execution. Some of the common registers include the program counter (PC), instruction register (IR), accumulator, and general-purpose registers. Processors can include a bus interface unit (BIU). The BIU is responsible for managing the communication between the processor and the external memory and input/output devices. It controls the transfer of data and instructions between the microprocessor and other components via the data bus, address bus, and control bus. Processors can also include cache memory. The cache memory is small, high-speed memory located close to the microprocessor core. It stores frequently accessed data and instructions to reduce memory access latency. The cache memory helps improve overall performance by providing faster access to frequently used data. Processors also can support multiple hardware and software interrupts to enable fast responses to external signals by triggering internal processing states and/or error recovery scenarios. Modern processors are complex systems that are implemented as integrated circuits that can include a variety of different components.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions to be executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool which in turn creates the gate-level abstraction of the design that is used for downstream implementation operations.

### SUMMARY

Prefetching is a technique used in processors to improve memory access

latency and overall system performance. It involves predicting future memory accesses and fetching the required data in advance, before it is needed by the processor. Prefetching can offer several benefits. One such benefit is reduced memory latency. By fetching data in advance, prefetching reduces the time required to access data from the main memory. This helps to hide or overlap memory access latency with other instructions, allowing the processor to continue executing instructions without waiting for data to arrive. One contributing factor for the reduced memory latency is an increased cache hit rate that can result from effective prefetching. The cache hit rate is the percentage of memory accesses that can be satisfied from the cache. By bringing in data that is likely to be accessed in the near future, prefetching increases the chances of data being present in the cache when it is needed, reducing cache misses and improving overall performance. Another benefit of prefetching is enhanced scalability. Prefetching can be particularly beneficial in multi-core or multi-processor systems. By reducing memory contention and improving cache utilization, prefetching can enhance system scalability and enable better utilization of the available computational resources. Overall, prefetching is an effective technique for reducing memory latency, improving instruction throughput, increasing cache hit rates, and enhancing overall system performance in modern processors. However, the effectiveness of prefetching is a function of the effectiveness of making predictions about what data and/or instructions will be needed.

Disclosed embodiments provide techniques for polarity-based data prefetching with underlying stride detection. A processor core includes a local cache hierarchy, prefetch logic, and a prefetch table, where the processor core is coupled to an external memory system. A data stream is detected, where the data stream includes multiple load instructions, including a load instruction that causes a cache miss, resulting in prefetching. A prefetch table is initialized with information pertaining to load instructions, and includes a Positive or Negative value (PON), a stride, and a saturation count. Information in the prefetch table is updated as new load instructions are prefetched. An underlying stride of the data stream is discovered, based on the updating. Data is prefetched using an offset, where a polarity of the offset is based on the PON, enabling effective stride detection with changing (dynamic) directionality and out-of-order instructions.

A processor-implemented method for data prefetching is disclosed comprising: accessing a processor core, wherein the processor core executes instructions out of order (OOO), wherein the processor core includes a local cache hierarchy, prefetch logic, and a prefetch table, and wherein the processor core is coupled to an external memory system; detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table; initializing an entry of the prefetch table with information pertaining to the first load instruction, wherein the information includes a last address, a maximum address, a minimum address, a Positive or Negative value (PON), a stride, and a saturation count; revising the information in the entry of the prefetch table, wherein the revising is based on the second load instruction, wherein the revising includes an initial stride, wherein the initial stride comprises an absolute value of a difference between the last address and the second data address; updating the information in the entry of the prefetch table, wherein the updating is based on the third load instruction, wherein the updating includes a second stride, wherein the second stride comprises an absolute value of a difference between the last address and the third data address; discovering an underlying stride of the data stream, wherein the discovering is based on the updating; and prefetching data from the last address plus an offset, wherein a polarity of the offset is based on the PON, and wherein the saturation count is above a first threshold. In embodiments, the initializing further comprises assigning the last address, the maximum address, and the minimum address to the first data address, assigning the PON to a neutral value, and assigning the saturation count and the stride to 0. In embodiments, the revising further comprises replacing the last address with the second data address. Some embodiments comprise replacing, in the entry of the prefetch table, the stride with the initial stride.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an out-of-order data prefetcher with underlying stride detection.

FIG. 2 is a flow diagram for revising and updating prefetch information.

FIG. 3 is a block diagram illustrating a multicore processor.

FIG. 4 is a block diagram for a pipeline.

FIG. 5 is a block diagram for initializing a prefetch table.

FIG. 6 is an illustration of prefetching with an underlying stream and positive stride detection.

FIG. 7 is another illustration of prefetching with an underlying stream and positive stride detection.

FIG. 8 is an illustration of prefetching with an underlying stream and negative stride detection.

FIG. 9 is an illustration of resetting a prefetch table entry.

FIG. 10 is a system diagram for a polarity-based data prefetcher with underlying stride detection.

### DETAILED DESCRIPTION

Prefetching is a technique used in processors to improve memory access latency and overall system performance. It involves predicting future memory accesses and fetching the required data in advance, before it is needed by the processor. One factor that can be used in prefetching is a data stride. A data stride refers to the pattern or interval between successive accesses to elements in a data structure, such as an array or a cache line. The data stride indicates the distance, in terms of memory locations or bytes, between two consecutive elements accessed in memory. The data stride plays a significant role in determining the efficiency of memory access and cache utilization. It influences the performance of the memory hierarchy, including levels of cache, main memory, and even the performance of the processor itself. Disclosed embodiments analyze data stride to help improve memory access patterns and reduce cache misses, leading to better overall performance.

Another technique for improving processor performance is out-of-order (OOO) instruction execution. OOO execution is a feature that enables processors to improve instruction-level parallelism and overall performance. It allows instructions to be executed in a different order than they appear in the program, subject to data dependencies and program semantics. Out-of-order execution allows the processor to identify independent instructions that can be executed simultaneously, thereby increasing the amount of work that can be done in parallel. This helps in exploiting the available execution resources more efficiently and improving overall performance. Furthermore, by reordering instructions dynamically, out-of-order execution helps in maximizing the usage of execution units within the processor, enabling the processor to schedule instructions on available functional units based on their availability, reducing idle time, and improving throughput.

Although both prefetching based on stride and out-of-order instructions can improve processor performance, the two techniques can potentially interfere with each other, which could adversely affect processor performance. For efficient prefetching, it can be helpful to identify a stride. When an instruction stream contains out-of-order instructions, identifying a stride can be challenging since the instructions are not in order. Disclosed embodiments address the aforementioned issues and enable effective coexistence of both OOO execution and prefetching by providing techniques for polarity-based data prefetching with underlying stride detection, enabling the combination of out-of-order instructions along with efficient stride-based prefetching to increase overall processor performance.

Processors utilize load instructions to load data from memory for computational purposes. Data structures such as arrays are useful for performing various calculations, including vector operations, image processing operations, and so on. Looping constructs, such as for loops, while loops, and the like, can iterate through large amounts of data to perform operations such as arithmetic and/or logical operations in order to perform a task. Depending on the task being performed, a particular pattern of access may be used. Access patterns can follow a stride. Examples of stride-based access can include accessing a column of elements within a matrix stored in memory, and/or accessing specific elements in an array of data structures. A regular pattern can be detected, such as X, X+8, X+16, etc. In general, for a stride S, with a prefetch depth of N, the stride prefetching can prefetch data from a base address X, as follows: X+S, X+2S, . . . X+NS. The stride prefetching can have a directionality. For example, in certain computational tasks, a process may start at the end of an array, and iterate toward the beginning of an array. In this case, the stride can have a negative direction (polarity), resulting in a stride pattern as follows: X−S, X−2S, . . . X−NS. The detecting of a stride can be based on the difference in address locations corresponding to two or more consecutive load instructions. The detecting of a stride can include detecting a directionality.

Detecting a stride is important for taking advantage of potential performance gains of a prefetcher system. A stride can change during the course of execution of a task. For example, an access pattern can access memory locations spaced 64 bytes apart from each other for a period of time, and then switch to accessing memory locations spaced 256 bytes apart for a second period of time. Detecting a stride change is important for resetting and/or reconfiguring the prefetcher to adapt to a new stride. Further complicating stride detection is that the directionality of the stride can change. For example, certain computations require multiple passes on a set of data. Some computations may perform operations from the beginning of a data structure such as a list or array. Then, a second pass may operate in reverse, starting from the end of the data structure and working back to the beginning of the data structure. Detecting a change in directionality is also important for resetting and/or reconfiguring the prefetcher to adapt to a new stride direction. Out-of-order (OOO) execution can yet further complicate the ability to detect a stride. A pipelined processor may execute load instructions out of order, for performance purposes. However, with the load addresses being fetched out of order, determining a stride may not always be a straightforward operation.

Disclosed embodiments address the aforementioned challenges by providing techniques for polarity-based data prefetching with underlying stride detection. A processor core includes a local cache hierarchy, prefetch logic, and a prefetch table, where the processor core is coupled to an external memory system. A data stream is detected, where the data stream includes at least a first load instruction with a first data address, a second load instruction with a second data address, and a third load instruction with a third data address, wherein the first load instruction causes a data miss in the local cache hierarchy, and where the first data address, the second data address, and the third data address index a same entry in the prefetch table. The prefetch table is initialized with information pertaining to the first load instruction, where the information includes a last address, a maximum address, a minimum address, a Positive or Negative value (PON), a stride, and a saturation count. The entry of the prefetch table is revised, where the revising is based on the second load instruction, where the revising includes an initial stride, and where the initial stride comprises an absolute value of a difference between the last address and the second data address. The information in the entry of the prefetch table is updated, where the updating is based on the third load instruction, where the updating includes a second stride, and where the second stride comprises an absolute value of a difference between the last address and the third data address. An underlying stride of the data stream is discovered, based on the updating. Data from the last address plus an offset is prefetched, where a polarity of the offset is based on the PON, and where the saturation count is above a first threshold. These techniques facilitate improved processor performance by enabling effective stride detection with dynamic directionality and OOO instructions.

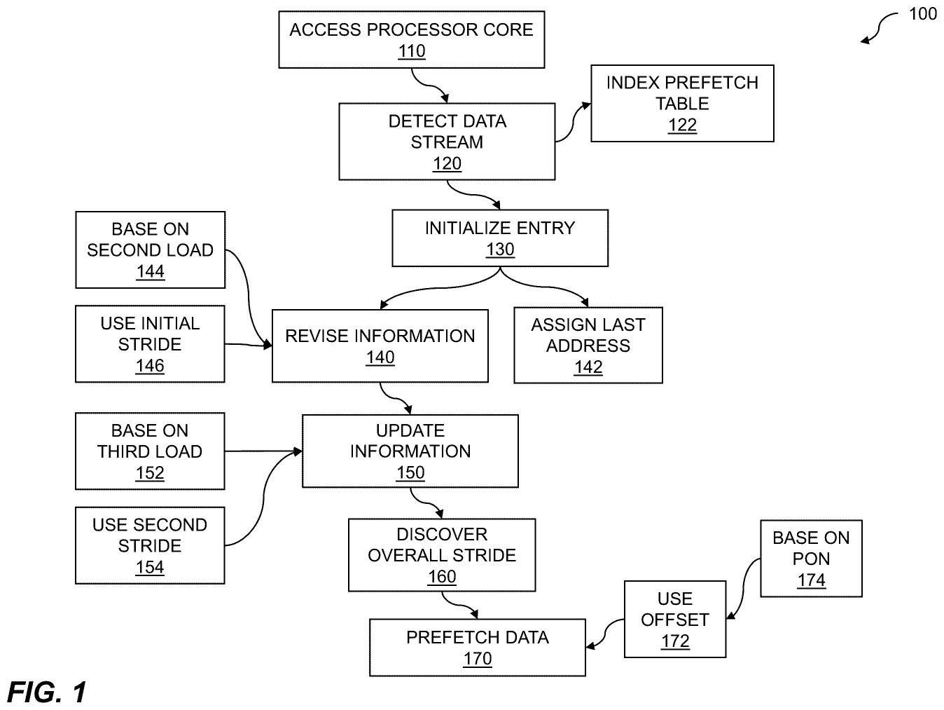

FIG. 1 is a flow diagram for an out-of-order data prefetcher with underlying stride detection. The flow 100 includes accessing a processor core 110. In one or more embodiments, the processor core executes instructions out of order (OOO), where the processor core includes a local cache hierarchy, prefetch logic, and a prefetch table, and where the processor core is coupled to an external memory system. The flow continues with detecting a data stream 120. The data stream can include at least a first load instruction with a first data address, a second load instruction with a second data address, and a third load instruction with a third data address, where the first load instruction causes a data miss in the local cache hierarchy. The data misses can trigger prefetching. The flow can include indexing in a prefetch table 122. In embodiments, the first data address, the second data address, and the third data address index a same entry in the prefetch table. In embodiments, the most significant X bits of an address are hashed, and the hashing corresponds to an entry in a prefetching table. In this way, addresses that are in proximity to each other can hash to the same entry in the prefetching table. In embodiments, the value of X can be configurable via a register. As an example, using 64-bit addresses, and with X having a value of 48, the most significant 48 bits of the address are hashed. In some embodiments, the value of X is 15. Thus, in embodiments, the hashed program counter comprises 15 bits of a program counter.

The flow continues with initializing an entry 130 in the prefetch table. The information that is initialized can include, but is not limited to, a last address, a maximum address, a minimum address, a Positive or Negative value (PON), a stride, and a saturation count. In embodiments, the PON is a multiple bit field, and the initialization may include setting a PON value to a midpoint of the bit field. As an example, the PON can be a 3-bit field. Three bits enable eight possible values, including a minimum value of zero and a maximum value of 7. In this case, the initialization can include setting the PON to a value of 3. In general, for a PON having a width of Z bits, the initialization value I may be specified as:

$$I = 2 \hat{} ( Z - 1 ) - 1 .$$

The initialization value may also define a threshold for the PON. In one or more embodiments, PON values at or above the threshold (neutral value) correspond to a positive stride directionality, and PON values below the threshold correspond to a negative stride directionality. In embodiments, the initialization value and threshold are specified as described above. However, disclosed embodiments can also support setting the PON threshold and initializing the PON to other values. In one or more embodiments, the PON initial value can be established by writing the value to a register. In cases where the directionality tends to skew toward a particular polarity (positive or negative), the PON initial value and threshold may also be set accordingly to favor a particular directionality. This can be specified by using a weighting factor W, in which case the initialization value I may be specified as:

$$I = 2 \hat{} ( Z - 1 ) - 1 - W .$$

The value of W may be specified in a register, stored as a signed value. In the case where the value of W is zero, the initialization value I is in the midpoint of the PON value range. A positive value of W skews the PON toward operating in a positive directionality. Conversely, a negative value of W skews the PON toward operating in a negative directionality. As an example, if Z is 3 and W is 1, then the value of I is computed as:

$$I = 2 \hat{} ( 3 - 1 ) - 1 - 1 = 2 .$$

With I=2 as the threshold, and the PON value ranging from 0 to 7, there are more possible PON values associated with positive stride than negative stride. A similar principle applies for negative values of W. Thus, in disclosed embodiments, the PON initial value and threshold may be configured dynamically by programming registers accordingly, prior to starting the prefetching.

The flow includes revising information 140. The revising includes revising the information in the entry of the prefetch table, where the revising is based on the second load instruction, where the revising includes an initial stride, and where the initial stride comprises an absolute value of a difference between the last address and the second data address. The flow includes assigning the last address 142. Assigning the last address can include storing the most recently fetched address in an entry of the prefetch table. The flow can include basing the revising on the second load 144. This can include recording the address corresponding to the second load instruction in the prefetch table. The flow can include using an initial stride 146. In one or more embodiments, the initial stride comprises an absolute value of a difference between the last address and the second data address.

The flow includes updating information 150. The updating can be based on the third load 152, and can include computing and using a second stride 154. Thus, in one or more embodiments, the updating is based on the third load instruction, wherein the updating includes a second stride, wherein the second stride comprises an absolute value of a difference between the last address and the third data address. The flow includes discovering an overall stride 160. In one or more embodiments, the discovering is based on the updated information. The updated information utilizes the PON. The PON provides a hysteresis function for directionality. The hysteresis can be beneficial for performance because there is overhead in reconfiguring the prefetcher, and the hysteresis can reduce “false positives” where a “one-off” pattern anomaly could otherwise cause a reconfiguring of the prefetcher. The flow includes prefetching data 170. The prefetching can include using an offset 172. In embodiments, the offset is based on the PON 174. The offset can also be based on the discovered overall stride. In embodiments, the combination of the stride and the PON value specifies one or more address locations to prefetch.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

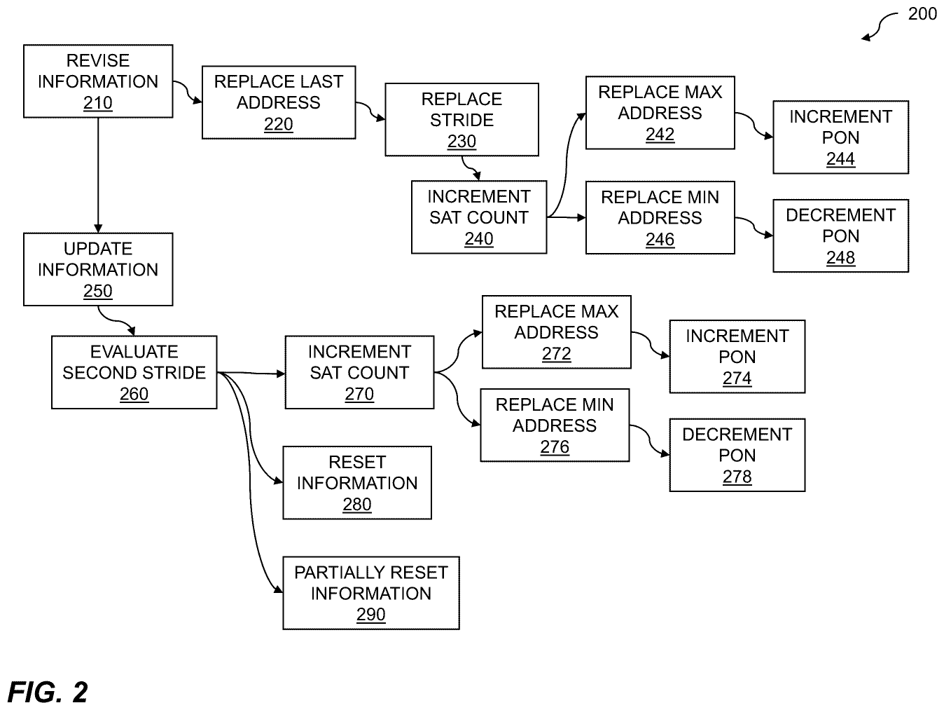

FIG. 2 is a flow diagram for revising and updating prefetch information. The flow 200 includes revising information 210. The revising can include replacing the last address 220. Replacing the last address can include replacing the last address with the second data address. In general, as each new address is prefetched, it is entered in a last address field of the prefetch table. The flow includes replacing a stride 230. The replacing of the stride can include replacing, in the entry of the prefetch table, the stride with the initial stride. The flow can further include incrementing a saturation count 240. The saturation count enables an additional element of hysteresis. In embodiments, a saturation threshold is specified. In one or more embodiments, the saturation threshold is specified by writing the threshold value to a register. Once the saturation threshold is reached, the prefetcher enters a saturation state, and the prefetcher becomes active. This technique can help reduce unnecessary prefetches for short instruction sequences. In one or more embodiments, the predetermined threshold can be programmed to configure the aggressiveness of the prefetcher. A higher value for the predetermined saturation threshold results in a more conservative prefetching operation. Conversely, a lower value for the predetermined threshold results in a more aggressive prefetching operation.

The flow can include replacing a maximum address 242. The flow can further include incrementing the PON 244. In embodiments, when a new maximum address is seen, the PON value is incremented (if the PON value is currently below its maximum value). The flow can include replacing a minimum address 246. The flow can further include decrementing the PON 248. Similar to the case for a new maximum value, when a new minimum address is seen, the PON value is decremented (if the PON value is currently above its minimum value). The flow can include updating information 250. This can include updating information in the prefetch table. The flow can include evaluating a second stride 260. The second stride can be based on subsequent load instructions. The flow can include performing similar operations as previously described each time the stride changes. Thus, the flow can include incrementing the saturation count 270, and can further include replacing a maximum address 272. The flow can further include incrementing the PON 274. In embodiments, when a new maximum address is seen, the PON value is incremented (if the PON value is currently below its maximum value). The flow can include replacing a minimum address 276. The flow can further include decrementing the PON 278. Similar to the case for a new maximum value, when a new minimum address is seen, the PON value is decremented (if the PON value is currently above its minimum value).

The flow can further include resetting information 280 or partially resetting information 290. There are various criteria that are evaluated to determine if a partial reset or a reset (full reset) is to be performed. Disclosed embodiments perform a partial reset when a new stride that is smaller than a current stride is detected. As an example, if a current stride is 4 and a new stride is detected as 3, then the address information of the prefetcher is reset to the last address that indexed the prefetch table, while the PON value and the count value within the prefetch control information are reset to their corresponding initial values. The stride count is set to the new stride count as computed based on the absolute value of the difference between the current address and the last address in the entry of the prefetch table. This is referred to as a partial reset. In a situation where a new stride is greater than the current stride and is not an integer multiple of the current stride, then a reset (full reset) is performed. In the full reset, the address information of the prefetcher is reset to the last address that indexed the prefetch table, and the prefetch control information is also reset to its initial values. As an example, if a new stride is determined to have a value of 10 and the current stride has a value of 4, then a full reset is performed since 10 is greater than 4, but 10 is not an integer multiple of 4. In a situation where a new stride is greater than the current stride and the new stride is also an integer multiple of the current stride, then no reset is performed. This enables the prefetchers of disclosed embodiments to ignore certain transient discontinuities that can be caused by out-of-order prefetching and/or other scenarios. As another example, if a new stride is determined to have a value of 12 and the current stride has a value of 4, then no reset is performed since 12 is an integer multiple of 4. By supporting a partial reset, disclosed embodiments can enable improved performance since the address information of the prefetcher can be used, avoiding the need to repopulate it with subsequent load instructions before initiating the prefetch operations.

In embodiments, the updating further comprises evaluating the second stride. In embodiments, the second stride is greater than or equal to the initial stride. In embodiments, the second stride is an integer multiple of the initial stride. In embodiments, the updating further comprises incrementing the saturation count if the saturation count is below the first threshold. Embodiments can include partially resetting the information within the entry of the prefetch table, wherein the partially resetting includes setting the last address, the maximum address, and the minimum address to the third data address, zeroing the saturation count, setting the stride to the second stride, and setting the PON to a neutral value. In embodiments, the PON count comprises a 3-bit counter.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

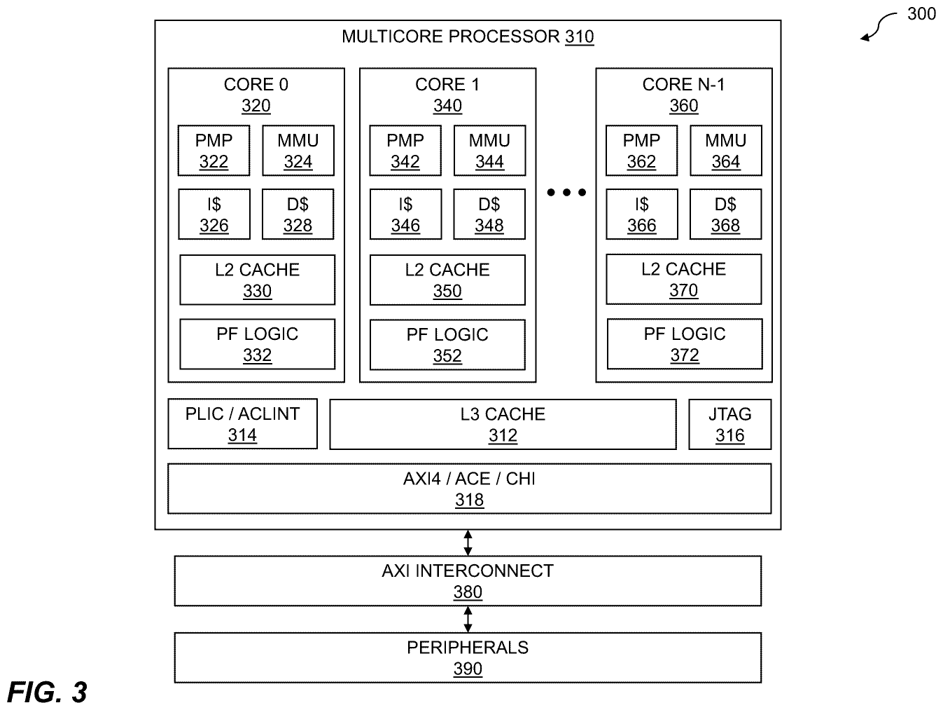

FIG. 3 is a block diagram illustrating a multicore processor with a polarity-based data prefetcher with underlying stride detection. In embodiments, the multicore processor can be a RISC-V™ processor, ARM™ processor, MIPS™ processor, or some other suitable processor type. The processor can include a multi-core processor, where two or more processor cores can be included. The processor, such as a RISC-V™ processor, can include a variety of elements. The elements can include processor cores, one or more caches, memory protection and management units (MMUs), local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by processor and network-on-chip coherency management. A plurality of processor cores is accessed. Each processor of the plurality of processor cores accesses a common memory through a coherent network-on-chip, and the coherent network-on-chip comprises a global coherency. A local cache is coupled to a grouping of two or more processor cores of the plurality of processor cores. Prefetcher logic can perform polarity-based data prefetching with underlying stride detection in order to increase the ratio of cache hits to cache access attempts, thereby improving processor performance.

The block diagram 300 can include a multicore processor 310. The multicore processor can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1 can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include an L2 cache 330 associated with core 0; an L2 cache 350 associated with core 1; and an L2 cache 370 associated with core N-1. A corresponding prefetch unit can include prefetch logic 332 associated with core 0; prefetch logic 352 associated with core 1; and prefetch logic 372 associated with core N-1. The prefetch logic 332, 352, and 372, can include logic gates and associated circuitry to enable a polarity-based data prefetcher with underlying stride detection. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

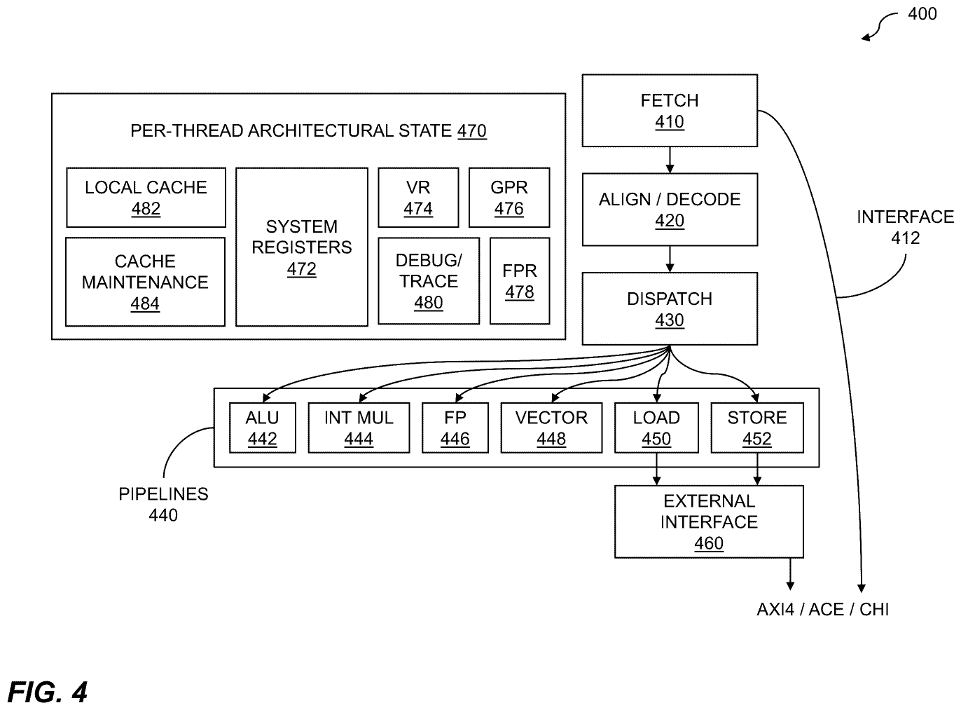

FIG. 4 shows a block diagram of a pipeline such as a core pipeline. The blocks within the block diagram can be configurable in order to provide varying processing levels. The varying processing levels can be based on processing speed, bit lengths, and so on. The block diagram 400 can include a fetch block 410. The prefetching logic of disclosed embodiments may be performed by the fetch block 410. The prefetching can include polarity-based data prefetching with underlying stride detection. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OOO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state block can be based on a configuration or architecture that can support multi-threading. In embodiments, thread selection logic can be included in the fetch and dispatch blocks discussed above. Further, when an architecture supports an out-of-order (OOO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

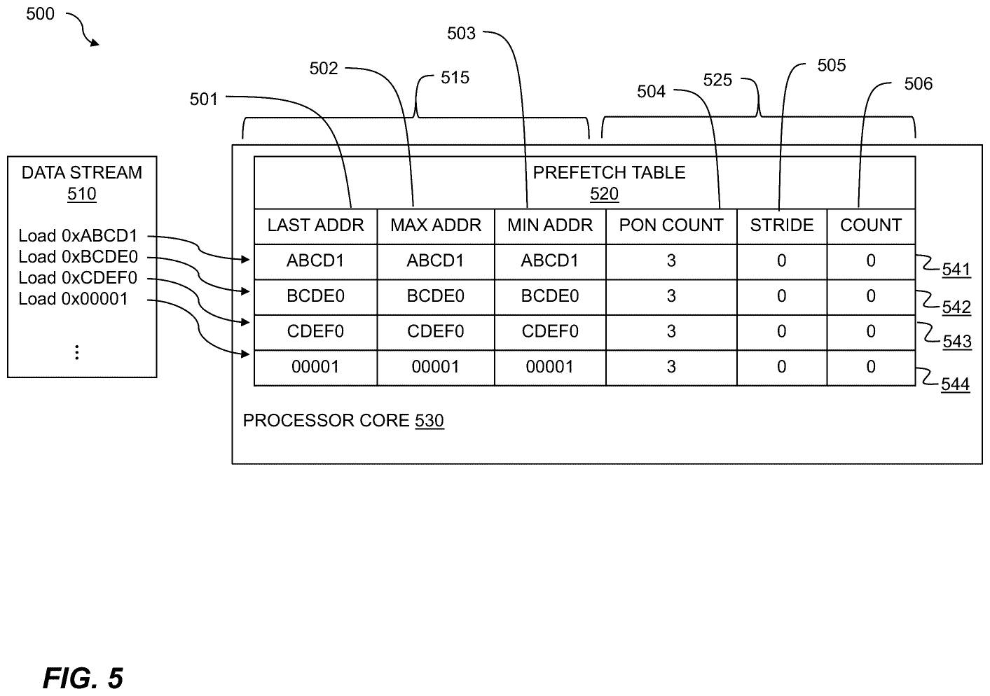

FIG. 5 is a block diagram for initializing a prefetch table. The prefetch table 520 can be disposed within a processor core 530. A data stream 510 includes multiple load addresses. The prefetch table 520 includes multiple columns. Column 501 shows a last address value. This value corresponds to the most recently seen address in the data stream 510. Column 502 shows a maximum address. This value corresponds to the highest value seen in the data stream 510. Column 503 shows a minimum address. This value corresponds to the lowest value seen in the data stream 510. Columns 501, 502, and 503 comprise address information 515. Column 504 is a PON count value. Column 505 is a stride value. Column 506 is a stride count value. Columns 504, 505, and 506 comprise prefetch control information 525.

The prefetch table 520 comprises four rows, indicated as 541, 542, 543, and 544. While four rows are shown in the prefetch table 520, embodiments may have more or fewer rows than four. Addresses in the data stream 510 are mapped to a given row of the prefetch table based on higher order bits within the addresses. In some embodiments, the higher order bits are hashed, and the hashed value is used to determine to which row, if any, within the prefetch table the address corresponds. For initialization, entries in the stride column 505 and the count column 506 are set to zero. Entries in the PON count column 504 are set to an initial value, which in this example is 3. In embodiments, the initial value is also a PON threshold value (neutral value). Thus, in block diagram 500, a PON count of 3 or higher corresponds to a positive stride, and a PON count of 2 or lower corresponds to a negative stride.

For the address information 515, each value, including the last address column 501, the maximum address column 502, and the minimum address column 503, are all set to the first load address from data stream 510 that maps to the corresponding row (541-544) within prefetch table 520. In embodiments, the initializing further comprises assigning the last address, the maximum address, and the minimum address to the first data address, assigning the PON to a neutral value, and assigning the saturation count and the stride to 0. In embodiments, the prefetch table is indexed by a hashed program counter. In embodiments, the hashed program counter comprises 15 bits of a program counter.

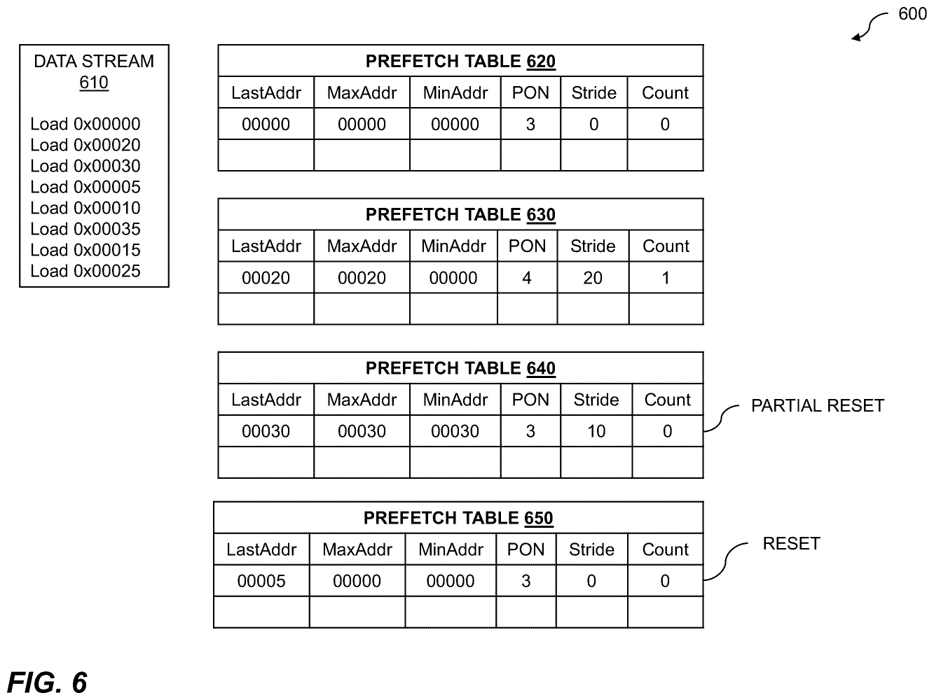

FIG. 6 is an illustration of prefetching with an underlying stream and positive stride detection. The illustration 600 includes a data stream 610 which includes multiple load addresses. For the purposes of the forthcoming examples illustrated in FIGS. 6-9, it is assumed that each load address in the data stream maps to the first row in the prefetch tables shown. It can be observed that all addresses in data stream 610 between 00000 and 00035 are represented with a stride of 5. However, the addresses are presented out of order. Disclosed embodiments can account for such out-of-order addresses and can detect an underlying stride (in this case, 5). Once detected, the prefetcher can then issue prefetch operations to attempt to avoid stalls in the processor core due to waiting for data.

Prefetch table 620 shows an initial condition in which the last address, maximum address, and minimum address are all set to the first seen address in the data stream, which is 00000. The PON is set to a neutral value (in this case 3), and the stride and the count are initialized to 0. The next address seen in the data stream is 00020. Accordingly, in prefetch table 630, since 00020 is the highest address yet seen in the data stream that indexes the first row of the prefetch table, the maximum address is updated to 00020. The minimum address value remains at 00000, since that is the lowest address value yet seen in the data stream that indexes the first row of the prefetch table. Referring now to the prefetch control information, the PON value is incremented by one each time the maximum address is updated (until the PON value reaches its maximum value, in this case 8). Thus, the PON is incremented to 4. The stride value is set to 20, which is the absolute value of the difference between 00020 (the current address) and 00000 (the last address). The difference can be in hexadecimal format. The saturation count value is incremented as well, and thus goes from 0 to 1. The saturation count value continues to increment until a saturation threshold is reached (in this case, 3), indicating that a data prefetch is to be executed. Finally, the last address value is updated to 00020.

The next address seen is 00030. Accordingly, in prefetch table 640, the new stride value is calculated to be 10, which is the absolute value of the difference between 00030(the current address) and 00020 (the last address). The difference can be in hexadecimal format. Because the new stride of 10 is less than the current stride of 20, a partial reset is performed. In the partial reset, the last address, maximum address, and minimum address are set to the next address seen (00030), the saturation count is set to 0, the PON is set to its initial neutral value (in this case, 3), and the stride is set to the new stride that was calculated (10). In embodiments, the partial reset includes setting the last address, the maximum address, and the minimum address to the third data address, zeroing the saturation count, setting the stride to the second stride, and setting the PON to a neutral value.

The next address seen is 00005. Accordingly, in prefetch table 650, the new stride value is calculated to be 25, which is the absolute value of the difference between 00005 (the current address) and 00030 (the last address). The difference can be in hexadecimal format. The new stride of 25 is greater or equal to the current stride of 10, thus, no partial reset is performed. However, because the new stride of 25 is not a positive integer multiple of the current stride of 10, a reset is performed. In a reset, the maximum address, minimum address, saturation count, and stride are all set to 0 and the PON is set to its initial neutral value (in this case, 3). The last address is set to the next address seen, which is 00005. In embodiments, the reset includes zeroing the maximum address, the minimum address, the saturation count, and the stride, and the reset sets the PON to a neutral value.

Embodiments can include replacing, in the entry of the prefetch table, the stride with the initial stride. Embodiments can include incrementing the saturation count, wherein the saturation count is less than the first threshold. Embodiments can include replacing, in the entry of the prefetch table, the maximum address with the second data address, if the second data address is greater than the maximum address. Embodiments can include incrementing, in the entry of the prefetch table, the PON, wherein the PON is below a second threshold. In embodiments, the revising further comprises replacing the last address with the second data address. Embodiments can include replacing, in the entry of the prefetch table, the maximum address with the third data address if the third data address is higher than the maximum address.

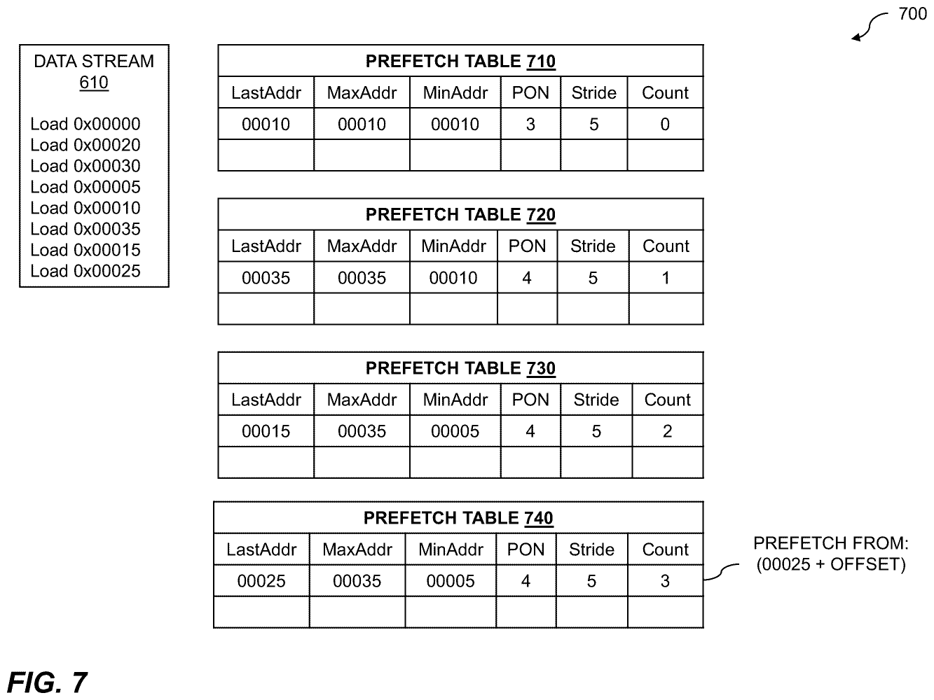

FIG. 7 is another illustration of prefetching with an underlying stream and positive stride detection. The illustration 700 continues the example shown in FIG. 6. Referring again to data stream 610, the next address seen is 00010. Accordingly, in the prefetch table 710, the new stride is calculated to be 5, which is the absolute value of the difference between 00010 (the current address) and 0005 (the last address). Since the entry had previously been reset, the minimum address and maximum address are set to the next address (00010), the PON value remains at its neutral value (in this case, 3), and the saturation count remains at 0. The last address is set to the next address seen, which is 00010.

The next address seen is 00035. Accordingly, in the prefetch table 720, the new stride is calculated as 25, the absolute value of the difference between 00035 (the current address) and 00010 (the last address). However, since 25 is a positive integer multiple of the current stride (5), the current stride of 5 remains in the entry of the prefetch table. In embodiments, when there is a new stride that is larger than the current stride and the new stride is also an integer multiple of the current stride, then the current stride remains in effect. The maximum address is updated to the next address seen (00035), since that is the highest address yet seen in the data stream that indexes the first row of the prefetch table. Similarly, since 00035 is not the lowest address yet seen in the data stream that indexes the first row of the prefetch table, the minimum address value remains at 00010. Referring now to the prefetch control information, the PON is incremented since the maximum address was updated, and thus, the PON value is now 4, indicating a positive offset for any potential prefetch operation. The last address value is updated to 00035. The saturation count is incremented to 1, but since it remains under the saturation threshold (3), no prefetch is performed at this point.

The next address seen is 00015. Accordingly, in prefetch table 730, the new stride is calculated as 20 (the absolute value of the difference between 00015 (the current address) and 00035 (the last address). However, since 20 is a positive integer multiple of the current stride (5), the current stride of 5 remains in the entry of the prefetch table. The maximum address is not updated since 00015, the current address, is not the highest address yet seen in the data stream that indexes the first row of the prefetch table. Thus, the maximum address remains at 00035. Similarly, since 00015 is also not the lowest address yet seen in the data stream that indexes the first row of the prefetch table, the minimum address value remains at 00005. Referring now to the prefetch control information, the PON does not change, since neither the maximum address nor the minimum address have updated. Thus, the PON value remains at 4. The saturation count is incremented to 2, but since the saturation count remains under the threshold (3), no prefetch is performed. The last address is updated to the next address seen (00015).

The next address seen is 00025. Accordingly, in prefetch table 740, the new stride is calculated as 10, the absolute value of the difference between 00025 (the current address) and 00015 (the last address). However, since 10 is a positive integer multiple of the current stride (5), the current stride of 5 remains in the entry of the prefetch table. Continuing with the example, since 00025 is not the highest address yet seen in the data stream that indexes the first row of the prefetch table, the maximum address does not change, remaining at 00035. Similarly, since 00025 is also not the lowest address yet seen in the data stream that indexes the first row of the prefetch table, the minimum address value remains at 00005. Referring now to the prefetch control information, the PON does not change, since neither the maximum address nor the minimum address have updated, and thus, the PON value remains at 4. The last address value is updated to 00025. The count value increments to 3, which in this example is the saturation threshold. As a result, a prefetch now occurs from the location specified in the last address field (00025), plus an offset. At this point, additional out-of-order addresses in the data stream with a stride of 5 will be prefetched correctly.

Embodiments can include replacing, in the entry of the prefetch table, the minimum address with the second data address if the second data address is less than the minimum address. Embodiments can include decrementing, in the entry of the prefetch table, the PON, wherein the PON is above a third threshold. Embodiments can include replacing, in the entry of the prefetch table, the minimum address with the third data address, if the third data address is lower than the minimum address.

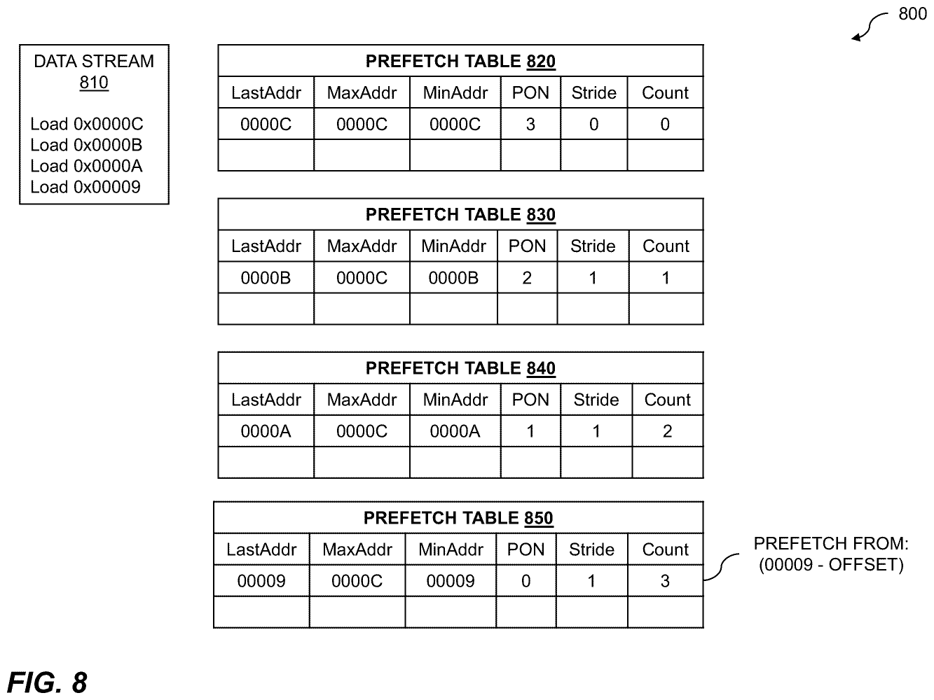

FIG. 8 is an illustration of prefetching with an underlying stream and negative stride detection. The illustration 800 depicts a data stream 810 which includes multiple load addresses. The prefetch table 820 shows an initial condition in which the last address, maximum address, and minimum address are all set to the first seen address, which is 0000C. The next address seen is 0000B. Accordingly, in prefetch table 830, since the value of 0000B is also the lowest address yet seen in the data stream that indexes the first row of the prefetch table, the minimum address is updated to 0000B. The maximum address does not change, remaining at 0000C. Referring now to the prefetch control information, the PON value is decremented by one each time the minimum address is updated (until the PON value reaches its minimum value), and thus, is now set at 2. As the value 2 is less than the PON threshold (neutral value) of 3, this signifies a negative polarity, and hence, detection of a negative stride. The stride value is set to 1, which is the absolute value of the difference between 0000B and 0000C (in hexadecimal format). The last address value is updated to 0000B. The count value is incremented as well, and thus goes from 0 to 1. The count value continues to increment until a saturation threshold is reached.

The next address seen is 0000A. Accordingly, in prefetch table 840, since that is also the lowest address yet seen in the data stream that indexes the first row of the prefetch table, the minimum address is updated to 0000A. The maximum address value remains at 0000C, since that is the highest address value yet seen in the data stream that indexes the first row of the prefetch table. Referring now to the prefetch control information, the PON value is decremented by one each time the minimum address is updated (until the PON value reaches its minimum value), and thus, is now set at 1. The stride value is set to 1, which is the absolute value of the difference between 0000A and 0000B (in hexadecimal format). The last address value is updated to 0000A. The count value is incremented as well, and thus goes from 1 to 2.The count value continues to increment until a saturation threshold is reached.

The next address seen is 00009. Accordingly, in prefetch table 850, since that is also the lowest address yet seen in the data stream that indexes the first row of the prefetch table, the minimum address is updated to 00009. The maximum address value remains at 0000C, since that is the highest address value yet seen in the data stream that indexes the first row of the prefetch table. Referring now to the prefetch control information, the PON value is decremented by one each time the minimum address is updated (until the PON value reaches its minimum value), and thus, is now set at 0, which is the minimum value for the PON. The stride value is set to 1, which is the absolute value of the difference between 00009 and 0000A (in hexadecimal format). The last address value is updated to 00009. The count value is incremented as well, and thus goes from 2 to 3. In this example, the saturation threshold is set to a value of 3, and a prefetch now occurs from the location specified in the last address field (00009), plus an offset. The offset can be determined based on a discovered stride. In embodiments, the offset can be based on a pipeline depth in the processor core. The polarity of the offset is based on the PON value. As the PON value of 0 is less than the neutral value of 3 (initialized as shown in prefetch table 820), the polarity as shown in prefetch table 850 is negative. Embodiments can include decrementing, in the entry of the prefetch table, the PON count, if the PON count is above a third threshold. Thus, prefetchers of disclosed embodiments can accommodate positive strides, negative strides, and out-of-order instructions.

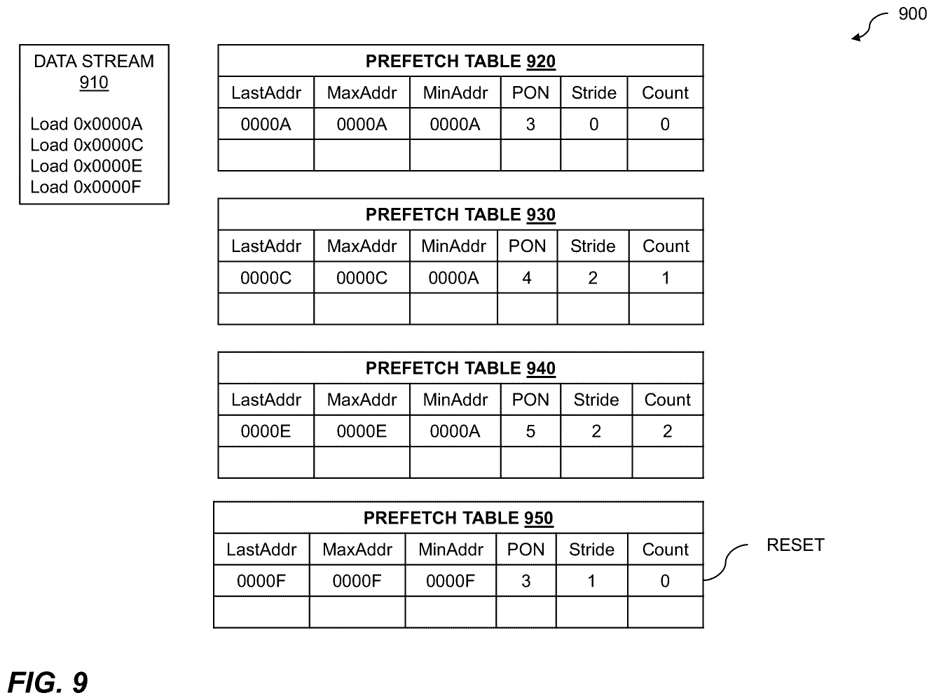

FIG. 9 is an illustration of resetting a prefetch table entry. The illustration 900 includes a data stream 910 which includes multiple load addresses. The prefetch table 920 shows an initial condition in which the last address, maximum address, and minimum address are all set to the first seen address, which is 0000A. The next address seen is 0000C. Accordingly, in prefetch table 930, since that is also the highest address yet seen in the data stream that indexes the first row of the prefetch table, the maximum address is updated to 0000C. The minimum address value remains at 0000A, since that is the lowest address value yet seen in the data stream that indexes the first row of the prefetch table. Referring now to the prefetch control information, the PON value is incremented by one each time the maximum address is updated (until the PON value reaches its maximum value), and thus, is now set at 4. The stride value is set to 2, which is the absolute value of the difference between 0000C and 0000A (in hexadecimal format). The count value is incremented as well, and thus goes from 0 to 1. The count value continues to increment until a saturation threshold is reached. The last address value is updated to 0000C.

The next address seen is 0000E. Accordingly, in the prefetch table 940, since that is also the highest address yet seen in the data stream that indexes the first row of the prefetch table, the maximum address is updated to 0000E. The minimum address value remains at 0000A, since that is the lowest address value yet seen in the data stream that indexes the first row of the prefetch table. Referring now to the prefetch control information, the PON value is incremented by one each time the maximum address is updated (until the PON value reaches its maximum value), and thus, is now set at 5. The stride value is set to 2, which is the absolute value of the difference between 0000E and 0000C (in hexadecimal format). The count value is incremented as well, and thus goes from 1 to 2. The count value continues to increment until a saturation threshold is reached. The last address value is updated to 0000E.

The next address seen is 0000F. Accordingly, in the prefetch table 950, since that is also the highest address yet seen in the data stream that indexes the first row of the prefetch table, the maximum address is updated to 0000F. The stride is computed as 1, which is the absolute value of the difference between 0000F and 0000E (in hexadecimal format). As 1 is not an integer multiple of 2, and as the new stride of 1 is less than the current stride of 2, a partial reset is performed, as previously described. This includes setting the last address, maximum address, and minimum address to the most recently seen address value of 0000F. Referring now to the prefetch control information, the PON value is reset to the default value of 3, the stride is set to 1, which is the absolute value of the difference between 0000F and 0000E (in hexadecimal), and the count is reset to zero. As can be seen in prefetch table 950, the partial reset leaves the address information and the stride value intact, while resetting the PON value and saturation count. In this way, disclosed embodiments can enable improved efficiency in accommodating changes in stride. In embodiments, the second stride is not an integer multiple of the initial stride. Embodiments can include resetting the information within the entry of the prefetch table, wherein the resetting includes zeroing the maximum address, the minimum address, the saturation count, and the stride, and wherein the resetting sets the PON to a neutral value. In embodiments, the second stride is less than the initial stride.

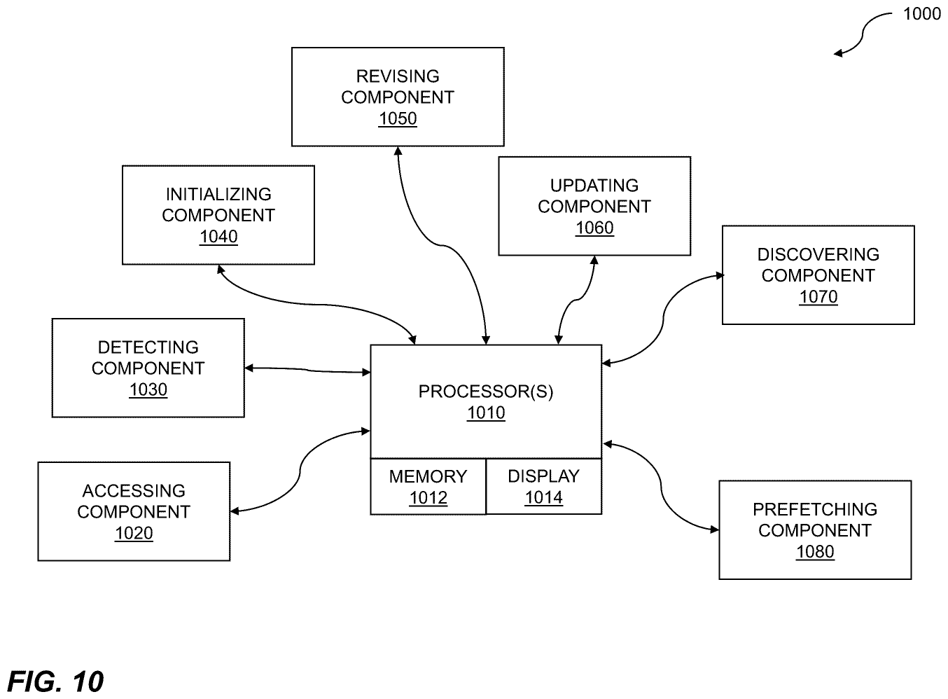

FIG. 10 is a system diagram for a polarity-based data prefetcher with underlying stride detection. The system 1000 can include instructions and/or functions for design and implementation of integrated circuits that support a polarity-based data prefetcher with underlying stride detection. The system 1000 can include instructions and/or functions for generation and/or manipulation of design data such as hardware description language (HDL) constructs for specifying structure and operation of an integrated circuit. The system 1000 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can include standalone processors within integrated circuits or chips, processor cores in FPGAs or ASICs, and so on. The one or more processors 1010 are coupled to a memory 1012, which stores operations. The memory can include one or more of local memory, cache memory, system memory, etc. The system 1000 can further include a display 1014 coupled to the one or more processors 1010. The display 1014 can be used for displaying data, instructions, operations, and the like. The operations can include instructions and functions for implementation of integrated circuits, including processor cores. In embodiments, the processor cores can include RISC-V™ processor cores. The system 1000 can include an accessing component 1020. The accessing component 1020 can include functions and instructions for processing design data for accessing a processor core. The processor core can include a local cache hierarchy, prefetch logic, and a prefetch table, where the processor core is coupled to an external memory system. The processor core can include FPGAs, ASICs, etc. In embodiments, the processor core can include a RISC-V™ processor core. The processor core can support a polarity-based data prefetcher with underlying stride detection, as previously described.

The system 1000 can include a detecting component 1030. The detecting component 1030 can include functions and instructions for processing design data for detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table. The system 1000 can include an initializing component 1040. The initializing component 1040 can include functions and instructions for processing design data for initializing an entry of the prefetch table with information pertaining to the first load instruction, wherein the information includes a last address, a maximum address, a minimum address, a Positive or Negative value (PON), a stride, and a saturation count. The system 1000 can include a revising component 1050. The revising component 1050 can include functions and instructions for processing design data for revising the information in the entry of the prefetch table, wherein the revising is based on the second load instruction, wherein the revising includes an initial stride, wherein the initial stride comprises an absolute value of a difference between the last address and the second data address. The system 1000 can include an updating component 1060. The updating component 1060 can include functions and instructions for processing design data for updating the information in the entry of the prefetch table, wherein the updating is based on the third load instruction, wherein the updating includes a second stride, wherein the second stride comprises an absolute value of a difference between the last address and the third data address. The system 1000 can include a discovering component 1070. The discovering component 1070 can include functions and instructions for processing design data for discovering an underlying stride of the data stream, wherein the discovering is based on the updating. The discovering can include computing an absolute value of a difference between a most recently seen address and a previously seen address. The system 1000 can include a prefetching component 1080. The prefetching component 1080 can include functions and instructions for processing design data for prefetching data from the last address plus an offset, wherein a polarity of the offset is based on the PON, and wherein the saturation count is above a first threshold.

The system 1000 can include a computer program product embodied in a non-transitory computer readable medium for instruction execution, the computer program product comprising code which causes one or more processors to perform operations of: accessing a processor core, wherein the processor core executes instructions out of order (OOO), wherein the processor core includes a local cache hierarchy, prefetch logic, and a prefetch table, and wherein the processor core is coupled to an external memory system; detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table; initializing an entry of the prefetch table with information pertaining to the first load instruction, wherein the information includes a last address, a maximum address, a minimum address, a Positive or Negative value (PON), a stride, and a saturation count; revising the information in the entry of the prefetch table, wherein the revising is based on the second load instruction, wherein the revising includes an initial stride, wherein the initial stride comprises an absolute value of a difference between the last address and the second data address; updating the information in the entry of the prefetch table, wherein the updating is based on the third load instruction, wherein the updating includes a second stride, wherein the second stride comprises an absolute value of a difference between the last address and the third data address; discovering an underlying stride of the data stream, wherein the discovering is based on the updating; and prefetching data from the last address plus an offset, wherein a polarity of the offset is based on the PON, and wherein the saturation count is above a first threshold.

The system 1000 can include a computer program product embodied in a non-transitory computer readable medium for instruction execution, the computer program product comprising code which causes one or more processors to generate semiconductor logic for: accessing a processor core, wherein the processor core executes instructions out of order (OOO), wherein the processor core includes a local cache hierarchy, prefetch logic, and a prefetch table, and wherein the processor core is coupled to an external memory system; detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table; initializing an entry of the prefetch table with information pertaining to the first load instruction, wherein the information includes a last address, a maximum address, a minimum address, a Positive or Negative value (PON), a stride, and a saturation count; revising the information in the entry of the prefetch table, wherein the revising is based on the second load instruction, wherein the revising includes an initial stride, wherein the initial stride comprises an absolute value of a difference between the last address and the second data address; updating the information in the entry of the prefetch table, wherein the updating is based on the third load instruction, wherein the updating includes a second stride, wherein the second stride comprises an absolute value of a difference between the last address and the third data address; discovering an underlying stride of the data stream, wherein the discovering is based on the updating; and prefetching data from the last address plus an offset, wherein a polarity of the offset is based on the PON, and wherein the saturation count is above a first threshold.

The system 1000 can include a computer system for instruction execution comprising: a memory which stores instructions; one or more processors attached to the memory wherein the one or more processors, when executing the instructions which are stored, are configured to: access a processor core, wherein the processor core executes instructions out of order (OOO), wherein the processor core includes a local cache hierarchy, prefetch logic, and a prefetch table, and wherein the processor core is coupled to an external memory system; detect a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table; initialize an entry of the prefetch table with information pertaining to the first load instruction, wherein the information includes a last address, a maximum address, a minimum address, a Positive or Negative value (PON), a stride, and saturation count; revise the information in the entry of the prefetch table, wherein the revising is based on the second load instruction, wherein the revising includes an initial stride, wherein the initial stride comprises an absolute value of a difference between the last address and the second data address; update the information in the entry of the prefetch table, wherein the updating is based on the third load instruction, wherein the updating includes a second stride, wherein the second stride comprises an absolute value of a difference between the last address and the third data address; discover an underlying stride of the data stream, wherein the discovering is based on the updating; and prefetch data from the last address plus an offset, wherein a polarity of the offset is based on the PON, and wherein the saturation count is above a first threshold.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods, and/or processor-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data prefetching comprising:
accessing a processor core, wherein the processor core executes instructions out of order (OOO), wherein the processor core includes a local cache hierarchy, prefetch logic, and a prefetch table, and wherein the processor core is coupled to an external memory system;
detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table;
initializing an entry of the prefetch table with information pertaining to the first load instruction, wherein the information includes a last address, a maximum address, a minimum address, a Positive or Negative value (PON), a stride, and a saturation count;
revising the information in the entry of the prefetch table, wherein the revising is based on the second load instruction, wherein the revising includes an initial stride, wherein the initial stride comprises an absolute value of a difference between the last address and the second data address;
updating the information in the entry of the prefetch table, wherein the updating is based on the third load instruction, wherein the updating includes a second stride, wherein the second stride comprises an absolute value of a difference between the last address and the third data address;
discovering an underlying stride of the data stream, wherein the discovering is based on the updating; and
prefetching data from the last address plus an offset, wherein a polarity of the offset is based on the PON, and wherein the saturation count is above a first threshold.

2. The method of claim 1 wherein the initializing further comprises assigning the last address, the maximum address, and the minimum address to the first data address, assigning the PON to a neutral value, and assigning the saturation count and the stride to 0.

3. The method of claim 1 wherein the revising further comprises replacing the last address with the second data address.

4. The method of claim 3 further comprising replacing, in the entry of the prefetch table, the stride with the initial stride.

5. The method of claim 4 further comprising incrementing the saturation count, wherein the saturation count is less than the first threshold.

6. The method of claim 5 further comprising replacing, in the entry of the prefetch table, the maximum address with the second data address, if the second data address is greater than the maximum address.

7. The method of claim 6 further comprising incrementing, in the entry of the prefetch table, the PON, wherein the PON is below a second threshold.

8. The method of claim 5 further comprising replacing, in the entry of the prefetch table, the minimum address with the second data address if the second data address is less than the minimum address.

9. The method of claim 8 further comprising decrementing, in the entry of the prefetch table, the PON, wherein the PON is above a third threshold.

10. The method of claim 1 wherein the updating further comprises evaluating the second stride.

11. The method of claim 10 wherein the second stride is greater or equal to the initial stride.

12. The method of claim 11 wherein the second stride is an integer multiple of the initial stride.

13. The method of claim 12 wherein the updating further comprises incrementing the saturation count if the saturation count is below the first threshold.

14. The method of claim 13 further comprising replacing, in the entry of the prefetch table, the maximum address with the third data address, if the third data address is higher than the maximum address.

15. The method of claim 14 further comprising incrementing, in the entry of the prefetch table, a PON count, if the PON count is below a second threshold.

16. The method of claim 13 further comprising replacing, in the entry of the prefetch table, the minimum address with the third data address, if the third data address is lower than the minimum address.

17. The method of claim 16 further comprising decrementing, in the entry of the prefetch table, a PON count, if the PON count is above a third threshold.

18. The method of claim 11 wherein the second stride is not an integer multiple of the initial stride.

19. The method of claim 18 further comprising resetting the information within the entry of the prefetch table, wherein the resetting includes zeroing the maximum address, the minimum address, the saturation count, and the stride, and wherein the resetting sets the PON to a neutral value.

20. The method of claim 10 wherein the second stride is less than the initial stride.

21. The method of claim 20 further comprising partially resetting the information within the entry of the prefetch table, wherein the partially resetting includes setting the last address, the maximum address, and the minimum address to the third data address, zeroing the saturation count, setting the stride to the second stride, and setting the PON to a neutral value.

22. The method of claim 1 wherein the prefetch table is indexed by a hashed program counter.

23. The method of claim 22 wherein the hashed program counter comprises 15 bits of a program counter.

24. The method of claim 1 wherein a PON count comprises a 3-bit counter.

25. A computer program product embodied in a non-transitory computer readable medium for instruction execution, the computer program product comprising code which causes one or more processors to generate semiconductor logic for:
accessing a processor core, wherein the processor core executes instructions out of order (OOO), wherein the processor core includes a local cache hierarchy, prefetch logic, and a prefetch table, and wherein the processor core is coupled to an external memory system;
detecting a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table;
initializing an entry of the prefetch table with information pertaining to the first load instruction, wherein the information includes a last address, a maximum address, a minimum address, a Positive or Negative value (PON), a stride, and a saturation count;
revising the information in the entry of the prefetch table, wherein the revising is based on the second load instruction, wherein the revising includes an initial stride, wherein the initial stride comprises an absolute value of a difference between the last address and the second data address;
updating the information in the entry of the prefetch table, wherein the updating is based on the third load instruction, wherein the updating includes a second stride, wherein the second stride comprises an absolute value of a difference between the last address and the third data address;
discovering an underlying stride of the data stream, wherein the discovering is based on the updating; and
prefetching data from the last address plus an offset, wherein a polarity of the offset is based on the PON, and wherein the saturation count is above a first threshold.

26. A computer system for instruction execution comprising:
a memory which stores instructions;
one or more processors coupled to the memory wherein the one or more processors, when executing the instructions which are stored, are configured to:
access a processor core, wherein the processor core executes instructions out of order (OOO), wherein the processor core includes a local cache hierarchy, prefetch logic, and a prefetch table, and wherein the processor core is coupled to an external memory system;
detect a data stream, wherein the data stream includes at least a first load instruction with a first data address, a second load instruction with a second data address, and a third load instruction with a third data address, wherein the first load instruction causes a data miss in the local cache hierarchy, and wherein the first data address, the second data address, and the third data address index a same entry in the prefetch table;
initialize an entry of the prefetch table with information pertaining to the first load instruction, wherein the information includes a last address, a maximum address, a minimum address, a Positive or Negative value (PON), a stride, and a saturation count;
revise the information in the entry of the prefetch table, wherein the revising is based on the second load instruction, wherein the revising includes an initial stride, wherein the initial stride comprises an absolute value of a difference between the last address and the second data address;
update the information in the entry of the prefetch table, wherein the updating is based on the third load instruction, wherein the updating includes a second stride, wherein the second stride comprises an absolute value of a difference between the last address and the third data address;
discover an underlying stride of the data stream, wherein the discovering is based on the updating; and
prefetch data from the last address plus an offset, wherein a polarity of the offset is based on the PON, and wherein the saturation count is above a first threshold.
